(19) United States
(12) Patent Application Publication
(10) Pub. No.: US 2026/0143056 A1
(43) Pub. Date: May 21, 2026

(54) DUAL CENTER POINT ROTATING BRACKET BASED ON ONE-KEY DUAL-DIMENSION TO GENERATE DAMPING SELF-LOCKING

(71) Applicant: WTL Technology Shenzhen Co., Ltd., Shenzhen (CN)

(72) Inventor: Tak Nam LIU, Shenzhen (CN)

(21) Appl. No.: 19/207,428

(22) Filed: May 14, 2025

(30) Foreign Application Priority Data
Nov. 20, 2024 (CN) 202422846479.2

(51) Int. Cl. H04M 1/04

(52) U.S. Cl. CPC H04M 1/04

(57) ABSTRACT

The utility model discloses a dual center point rotating bracket that is based on one-key dual-dimension to generate damping self-locking, including a fixed piece, a movable block, a movable shaft, a limit plane, a U-shaped frame, and a bracket plate, wherein the top of the fixed piece is attached with the movable block, and support grooves are symmetrically provided on the movable block; the present utility model utilizes the fixed piece as the connection part between the phone case and the bracket, and the movable shaft is sleeved in the hinge frame and U-shaped frame to support the bracket plate on the phone case.

### CROSS-REFERENCE TO RELATED APPLICATION

The present application is based upon and claims priority to Chinese patent application No. 2024228464792, filed on Nov. 20, 2024, the entire content of which is incorporated herein by reference.

### TECHNICAL FIELD

The present utility model relates to the field of mobile phone bracket technology, particularly to a dual center point rotating bracket that is based on one-key dual-dimension to generate damping self-locking.

### BACKGROUND

Devices available on the market such as mobile phones and tablets relate to viewing, photography, and other needs, the phone needs to be placed at a tilted angle on a desktop, or there should be a mechanism to assist in holding the procedures when taking photos. This requires the use of a bracket which is a hinge shaft with damping and self-locking functions; Many hinge shafts on the market are made of steel sheets rolled into cylindrical shapes to wrap around the shaft axis for rotation, and have functions such as damping, preloading, and self-locking. Rotation is realized only at a single center point, such that the folding becomes inconvenient and user's experience is affected; In further, the connection structure requires the use of tools for locking and fixing, increasing the product's production cost; therefore it is necessary to design a dual center point rotating bracket that is based on one-key dual-dimension to generate damping self-locking.

### SUMMARY

The purpose of the present utility model is to provide a dual center point rotating bracket that is based on one-key dual-dimension to generate damping self-locking, so as to address the problem faced by existing hinge shafts on the market made of steel sheets rolled into cylindrical shapes to wrap around the shaft axis for rotation, which have functions such as damping, preloading, and self-locking. Rotation is realized only at a single center point, such that the folding becomes inconvenient and user's experience is affected; In further, the connection structure requires the use of tools for locking and fixing, increasing the product's production cost.

In order to address above technical problem, the utility model provides the following technical solution: a dual center point rotating bracket that is based on one-key dual-dimension to generate damping self-locking, comprising a fixed piece, a movable block, a movable shaft, a hinge frame, a limit plane, a U-shaped frame, a square groove, an arc-shaped plate, a phone case, a hinge plate, an installation groove, a bracket plate, a storage groove, and a limit top plate; the top of the fixed piece is attached with the movable block, and support grooves are symmetrically provided on the movable block, a movable shaft is rotatably connected in the support groove, and the two ends of the movable shaft are sleeved in the hinge frame, the bottom of the hinge frame is machined with a limit plane that is attached to the fixed piece, the center of the movable shaft is sleeved in the U-shaped frame, the hinge frame is symmetrically disposed on the hinge plate that is fixedly sleeved in the installation groove.

As a further technical solution of the present utility model, the U-shaped frame is sleeved into a square groove, and the square groove is disposed on the movable block.

As a further technical solution of the present utility model, the bottom of the U-shaped frame is symmetrically provided with arc-shaped plates that are attached to the bottom of the fixed piece.

As a further technical solution of the present utility model, the fixed piece is fixedly installed in a circular hole, and the circular hole is disposed at the top of the phone case.

As a further technical solution of the present utility model, the installation groove is disposed on the bracket plate, and the bracket plate is slidably connected in the storage groove.

As a further technical solution of the present utility model, the storage groove is disposed at the top of the phone case.

As a further technical solution of the present utility model, a limit top plate is provided at the top of the movable block.

The utility model provides a dual center point rotating bracket that is based on one-key dual-dimension to generate damping self-locking, which has the following advantages: the fixed piece is used as the connection part between the phone case and the bracket, and during assembly, the U-shaped frame passes through the fixed piece and the square groove on the movable block and sleeved into the movable shaft, the movable shaft is pressed into the support groove and sleeved into the hinge frame and U-shaped frame to support the bracket plate on the phone case to complete the assembly process. The simple and easy-to-assemble structure reduces products'processing cost; After assembly, the movable shaft serves as the rotational support for the hinge frame and bracket plate, while the fixed piece serves as the rotational support for the movable block, U-shaped frame and arc-shaped plate, which replace traditional bracket structure to implement dual dimensional rotation and improve the practicality of the product; In the folded state, the limit plane on the hinge frame is attached to the fixed piece to implement bracket self-locking, and the bracket plate, after rotation, presses against the fixed piece for interference fit, and provides damping for limiting purpose and improve the user's experience.

### BRIEF DESCRIPTION OF THE DRAWINGS

In order to more clearly illustrate the technical solution of the embodiments of the present utility model or the prior art, a brief introduction will be given to the accompanying drawings required for the description of the embodiments. Obviously, the accompanying drawings described below are some embodiments of the present utility model. Those of ordinary skill in the art can obtain other drawings based on these drawings without creative work.

FIG. 1 is a schematic diagram of the overall structure of the present utility model;

FIG. 2 is an exploded view of the overall structure of the present utility model;

FIG. 3 is an enlarged partial view of area A in FIG. 2;

FIG. 4 is a three-dimensional diagram of a partial structure of the present utility model;

FIG. 5 is an exploded view of a partial structure of the present utility model.

Where: 1. Fixed piece; 2. Movable block; 3. Support groove; 4. Movable shaft; 5. Hinge frame; 6. Limit plane; 7. U-shaped frame; 8. Square groove; 9. Arc-shaped plate; 10. Circular hole; 11. Phone case; 12. Hinge plate; 13. Installation groove; 14. Bracket plate; 15. Storage groove; 16. Limit top plate.

### DETAILED DESCRIPTION OF THE EMBODIMENTS

In order to make the purpose, technical solution and advantages of the embodiments of the present utility model more clear, the technical solutions in the embodiments of the present utility model will be described clearly and completely in conjunction with the accompanying drawings of the embodiments of the present utility model. Obviously, the described embodiments are only a part of the embodiments of the present utility model, rather than all the embodiments. Based on the embodiments of the present utility model, all other embodiments obtained by those of ordinary skill in the art without creative work shall fall within the protection scope of the present utility model.

It should be noted that in the description of the present utility model, unless otherwise specified and limited, the terms “installation”, “connected”, and “connection” should be broadly understood, for example, can be fixed connection, detachable connection, or integral connection; can be mechanical connection or electrical connection; can be direct connection, indirect connection through an intermediate medium, or internal connection between two components. The person having ordinary skill in the art can understand the specific meanings of the above terms in the present utility model in specific situations.

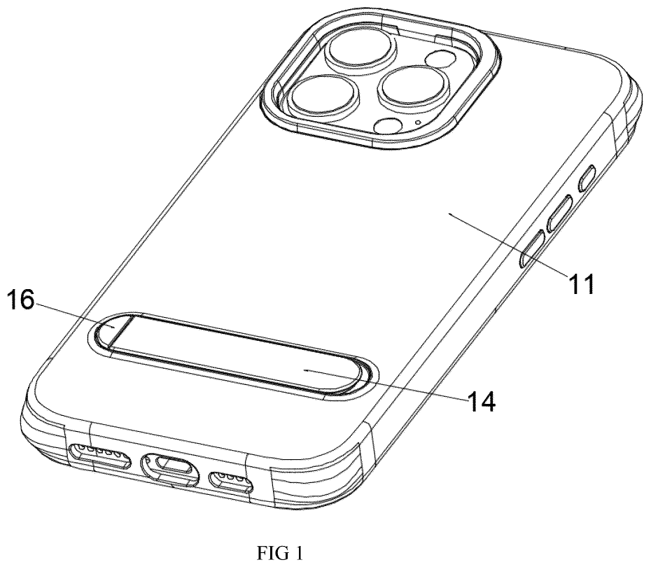

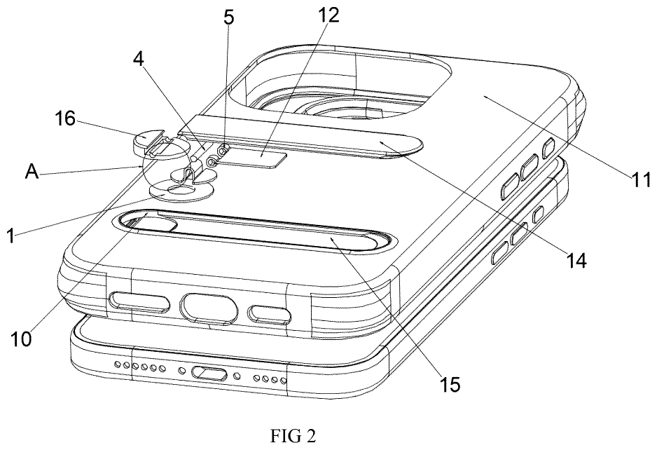

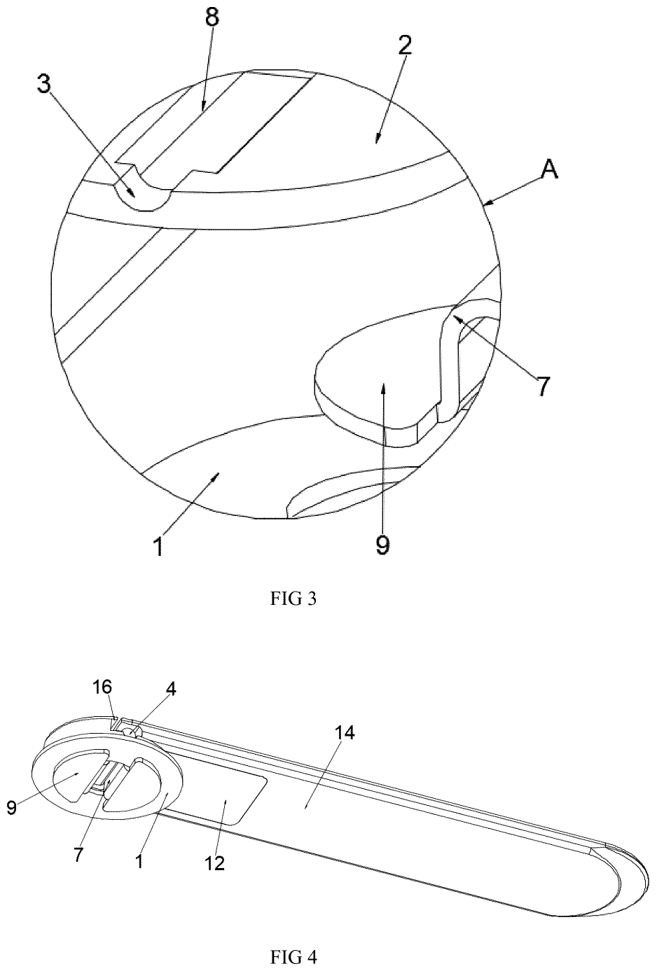

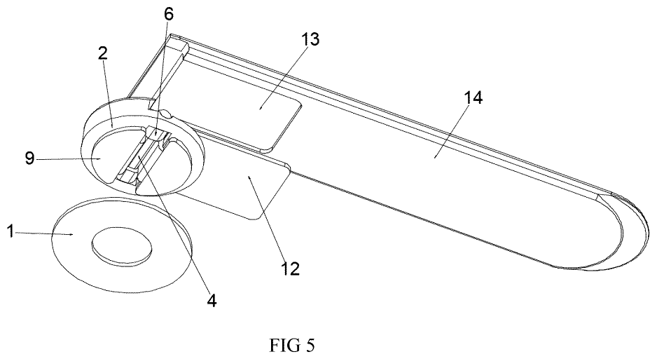

As shown in FIGS. 1-5, in an embodiment provided by the present utility model: A dual center point rotating bracket that is based on one-key dual-dimension to generate damping self-locking, comprising a fixed piece 1, a movable block 2, a movable shaft 4, a hinge frame 5, a limit plane 6, a U-shaped frame 7, a square groove 8, an arc-shaped plate 9, a phone case 11, a hinge plate 12, an installation groove 13, a bracket plate 14, a storage groove 15, and a limit top plate 16; the top of the fixed piece 1 is attached with the movable block 2, and support grooves 3 are symmetrically provided on the movable block 2, a movable shaft 4 is rotatably connected in the support groove 3, and the two ends of the movable shaft 4 are sleeved in the hinge frame 5, the bottom of the hinge frame 5 is machined with a limit plane 6 that is attached to the fixed piece 1, the center of the movable shaft 4 is sleeved in the U-shaped frame 7, the hinge frame 5 is symmetrically disposed on the hinge plate 12 that is fixedly sleeved in the installation groove 13; the U-shaped frame 7 is sleeved into a square groove 8, and the square groove 8 is disposed on the movable block 2; the bottom of the U-shaped frame 7 is symmetrically provided with arc-shaped plates 9 that are attached to the bottom of the fixed piece 1; the fixed piece 1 is fixedly installed in a circular hole 10, and the circular hole 10 is disposed at the top of the phone case 11; the installation groove 13 is disposed on the bracket plate 14, and the bracket plate 14 is slidably connected in the storage groove 15; the storage groove 15 is disposed at the top of the phone case 11; a limit top plate 16 is provided at the top of the movable block 2 to limit the rotation angle of bracket plate 14.

Specifically, during use, the fixed piece 1 is used as the connection part between the phone case 11 and the bracket, and during assembly, the U-shaped frame 7 passes through the fixed piece 1 and the square groove 8 on the movable block 2 and is sleeved into the movable shaft 4, the movable shaft 4 is pressed into the support groove 3 and sleeved into the hinge frame 5 and U-shaped frame 7 to support the bracket plate 14 on the phone case 11 to complete the assembly process. The simple and easy-to-assemble structure reduces products'processing cost; After assembly, the movable shaft 4 serves as the rotational support for the hinge frame 5 and bracket plate 14, while the fixed piece 1 serves as the rotational support for the movable block 2, U-shaped frame 7 and arc-shaped plate 9, which replace traditional bracket structure to implement dual dimensional rotation and improve the practicality of the product; In the folded state, the limit plane 6 on the hinge frame 5 is attached to the fixed piece 1 to implement bracket self-locking, and the bracket plate 14, after rotation, presses against the fixed piece 1 for interference fit, and provides damping for limiting purpose and improve the user's experience

It should be noted that in the description of the present utility model, unless otherwise specified and limited, the terms “installation”, “connected”, and “connection” should be broadly understood, for example, can be fixed connection, detachable connection, or integral connection; can be mechanical connection or electrical connection; can be direct connection, indirect connection through an intermediate medium, or internal connection between two components. The person having ordinary skill in the art can understand the specific meanings of the above terms in the present utility model in specific situations.

The above described embodiments of the device are only illustrative, where the units described as separate components may or may not be physically separated, and the components displayed as units may or may not be physical units, that is, they may be located in one place or distributed across a plurality of network units. Some or all of the modules can be selected according to actual needs to achieve the purpose of this embodiment. Those of ordinary skill in the art can understand and implement without creative labor.

Finally, it should be noted that the above embodiments are only used to illustrate rather than limit the technical solution of the present utility model; Although the present utility model has been described in detail with reference to the aforementioned embodiments, those of ordinary skill in the art should understand they can still modify the technical schemes described in the aforementioned embodiments or make equivalent replacements for some or all of technical features; such modifications or replacements do not depart from the spirit and scope of the technical schemes of the embodiments of the present utility model.

What is claimed is:

1. A dual center point rotating bracket that is based on one-key dual-dimension to generate damping self-locking, comprising a fixed piece, a movable block, a movable shaft, a hinge frame, a limit plane, a U-shaped frame, a square groove, an arc-shaped plate, a phone case, a hinge plate, an installation groove, a bracket plate, a storage groove, and a limit top plate; wherein the top of the fixed piece is attached with the movable block, and support grooves are symmetrically provided on the movable block, a movable shaft is rotatably connected in the support groove, and the two ends of the movable shaft are sleeved in the hinge frame, the bottom of the hinge frame is machined with a limit plane that is attached to the fixed piece, the center of the movable shaft is sleeved in the U-shaped frame, the hinge frame is symmetrically disposed on the hinge plate that is fixedly sleeved in the installation groove.

2. The dual center point rotating bracket of claim 1, wherein the U-shaped frame is sleeved into the square groove, and the square groove is disposed on the movable block.

3. The dual center point rotating bracket of claim 2, wherein the bottom of the U-shaped frame is symmetrically provided with the arc-shaped plates that are attached to the bottom of the fixed piece.

4. The dual center point rotating bracket of claim 3, wherein the fixed piece is fixedly installed in a circular hole, and the circular hole is disposed at the top of the phone case.

5. The dual center point rotating bracket of claim 1, wherein the installation groove is disposed on the bracket plate, and the bracket plate is slidably connected in the storage groove.

6. The dual center point rotating bracket of claim 5, wherein the storage groove is disposed at the top of the phone case.

7. The dual center point rotating bracket of claim 1, wherein the limit top plate is provided at the top of the movable block.
